(19) United States
(12) Patent Application Publication
(10) Pub. No.: US 2022/0002096 A1
(43) Pub. Date: Jan. 6, 2022

(54) SYSTEM AND METHOD FOR EGG HANDLING

(71) Applicant: Rose Acre Farms, Inc., Seymour, IN (US)

(72) Inventors: Daniel HELLE, West Lafayette, IN (US); Jeremy DURFLINGER, Rensselaer, IN (US); Kerry SELLERS, Brook, IN (US)

(73) Assignee: Rose Acre Farms, Inc.

(21) Appl. No.: 16/921,809

(22) Filed: Jul. 6, 2020

(51) Int. Cl. B65G 47/52; B65G 47/57; B65G 37/00

(52) U.S. Cl. CPC B65G 47/525; B65G 47/57; B65G 11/203; B65G 2201/0208; B65G 37/005

(57) ABSTRACT

A system and method for moving a plurality of eggs from a distal end of a feeder to a proximal end of a conveyor for loading the eggs onto the conveyor. The conveyor comprises a plurality of egg-receiving positions. The distal end of the feeder and the proximal end of the conveyor are aligned such that the plurality of egg-receiving positions accepts the plurality of eggs as the conveyor moves past the distal end of the feeder. A nozzle emitting a stream of fluid is positioned proximal to the distal end of the feeder so that the stream of fluid urges the plurality of eggs toward the distal end of the feeder.

### TECHNICAL FIELD OF THE DISCLOSED EMBODIMENTS

The presently disclosed embodiments generally relate to processing eggs, and more particularly, to systems and methods of moving a plurality of eggs from an egg feeder to a conveyor.

### BACKGROUND OF THE DISCLOSED EMBODIMENTS

The system 50 as illustrated in Prior Art FIG. 1 shows a plurality of eggs 52 moving from a feeder 54 onto a conveyor 56. In one embodiment, the eggs 52 enter the feeder 54 after being collected from an aviary and are deposited onto the conveyor 56 to be transported to a washing station (not shown). The feeder 54 is configured as a plurality of channels 55 arranged substantially parallel to one another. Each channel 55 aligns with a row of egg-receiving positions on conveyor 56. The eggs may move through each channel 55 of the feeder 54 toward the conveyor 56 by any desired means, such as by gravity, by vibration, by a conveyor belt, by the force of eggs entering the feeder 54, or by a combination of these or other motive forces. The moving conveyor 56 continuously presents egg-receiving positions at the end of each channel 55 of the feeder 54. As an egg 52 reaches the end of each channel 55 of the feeder 54, it is deposited into an egg-receiving position 58 and thereafter carried downstream by the conveyor 56. Improvements in this system are desired.

### SUMMARY OF THE DISCLOSED EMBODIMENTS

In one embodiment, a system for handling a plurality of eggs is disclosed, the system comprising: a feeder comprising a feeder proximal end for receiving the plurality of eggs, a feeder distal end opposite the feeder proximal end, a bottom surface, and a plurality of guide walls extending from the bottom surface between the feeder proximal end and the feeder distal end forming a plurality of channels between the plurality of guide walls; a conveyor comprising a conveyor proximal end and a plurality of egg-receiving positions spaced along the conveyor for receiving the plurality of eggs; at least one nozzle operative to emit a stream of fluid between pairs of the plurality of guide walls; wherein the plurality of eggs moves from the feeder proximal end along the bottom surface through the plurality of channels until each of the plurality of eggs reaches the feeder distal end; wherein the feeder distal end and the conveyor proximal end are positioned so that each of the plurality of egg-receiving positions is aligned to accept a respective one of the plurality of eggs from the feeder distal end; and wherein the nozzle is positioned proximal to the feeder distal end such that the stream of fluid urges the plurality of eggs to the feeder distal end so that the plurality of eggs is positioned to move into the plurality of egg-receiving positions as the conveyor proximal end moves past the feeder distal end.

In another embodiment, a method of handling a plurality of eggs is disclosed, the method comprising: loading the plurality of eggs onto a feeder proximal end; moving the plurality of eggs from the feeder proximal end to a feeder distal end opposite the feeder proximal end along a bottom surface and between a plurality of guide walls extending from the bottom surface between the feeder proximal end and the feeder distal end, the plurality of guide walls forming a plurality of channels; transitioning the plurality of eggs from the feeder distal end to a conveyor comprising a conveyor proximal end and a plurality of egg-receiving positions spaced along the conveyor for receiving the plurality of eggs; urging the plurality of eggs moving along the feeder through the plurality of channels with at least one nozzle operative to emit a stream of fluid into the plurality of channels proximal to the feeder distal end; wherein the plurality of eggs moving from the feeder proximal end travel through the channels until each of the plurality of eggs reaches the feeder distal end; wherein the feeder distal end and the conveyor proximal end are positioned so that each of the plurality of egg-receiving positions is aligned to accept a respective one of the plurality of eggs from the feeder distal end; and wherein the nozzle is positioned such that the stream of fluid urges the plurality of eggs into position to move into the plurality of egg-receiving positions as the conveyor proximal end moves past the feeder distal end.

Other embodiments are also disclosed.

### BRIEF DESCRIPTION OF DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is an illustration of a prior art egg handling system;

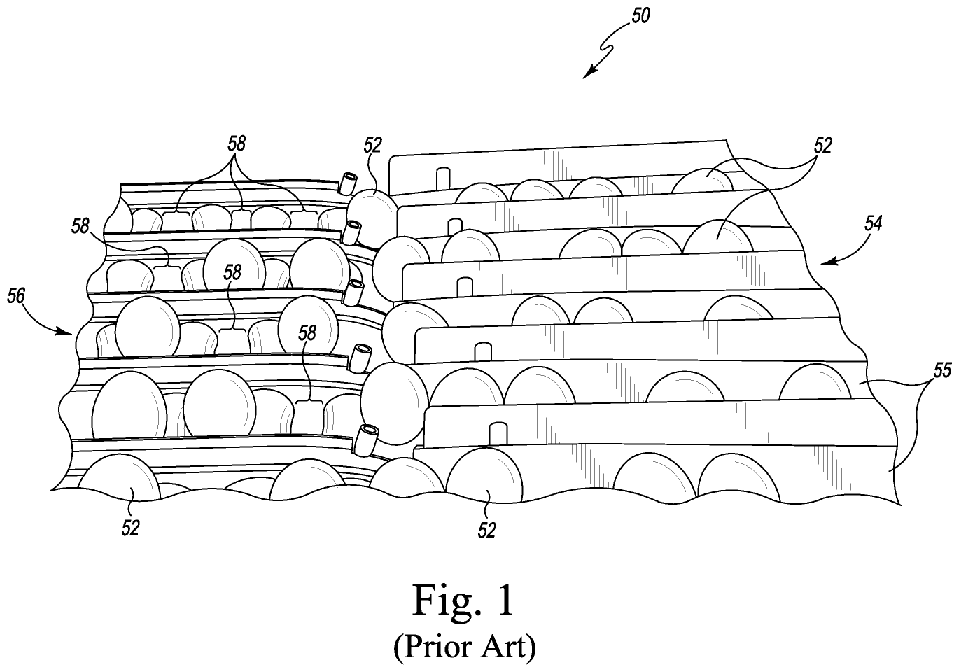

FIG. 2 is an illustrative embodiment of a system for handling a plurality of eggs;

FIG. 3 is a flowchart of a method for handling a plurality of eggs.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

Due to the plurality of eggs 52 not moving uniformly along each channel 55 of the feeder 54 to the conveyor 56, the conveyor 56 does not completely fill up with the plurality of eggs 52. This leaves undesirable open egg-receiving positions 58. As a result, the system 50 does not operate as efficiently as desired, resulting in longer periods of time to process a given quantity of the plurality of eggs 52. Therefore, a more efficient system and method for moving a plurality of eggs from an egg feeder to a conveyor is desirable.

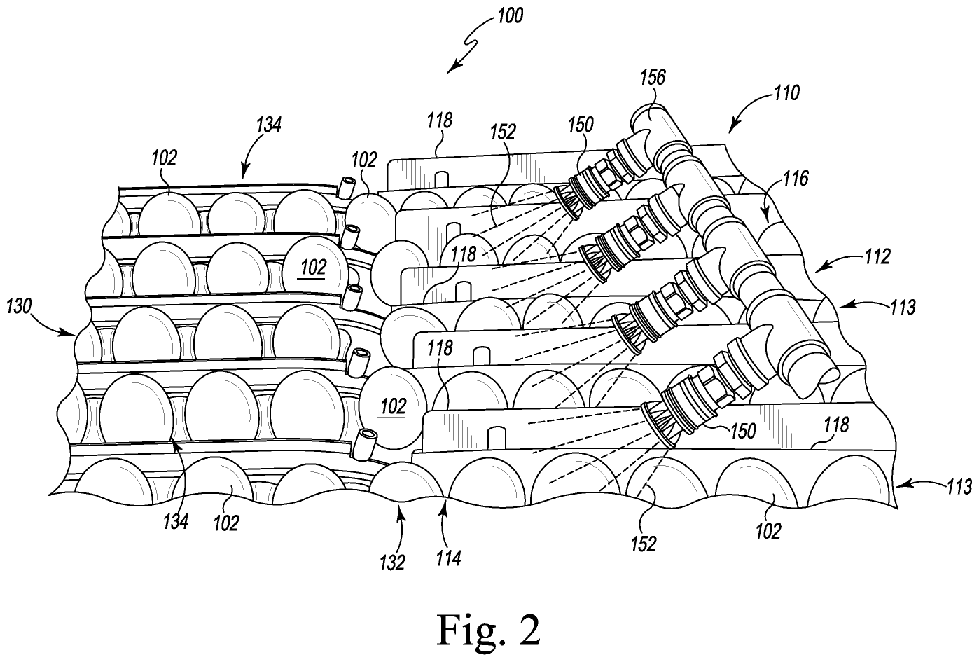

FIG. 2 illustrates a system 100 for handling a plurality of eggs 102. The system 100 may comprise a feeder 110, a conveyor 130, and at least one fluid nozzle 150. The system may be used to move the plurality of eggs 102 through various processing steps. For example, the system 100 may separate the plurality of eggs 102 received from an aviary and position them for loading the plurality of eggs 102 onto a conveyor 130, and the conveyor 130 may carry the plurality of eggs 102 through, e.g., a washing process (not shown).

The feeder 110 may comprise a feeder proximal end 112 for receiving the plurality of eggs 102, a feeder distal end 114 opposite the feeder proximal end 112, a bottom surface 116, and a plurality of guide walls 118 extending upward from the bottom surface 116 between the feeder proximal end 112 and the feeder distal end 114. The plurality of guide walls 118, together with the bottom surface 116, form a plurality of substantially parallel channels 113 for receiving the plurality of eggs 102 presented to the feeder 110 at its proximal end 112.

The plurality of eggs 102 may be loaded onto the feeder proximal end 112 in any desired manner and thereafter move along the feeder 110 in the channels 113 between the plurality of guide walls 118. The plurality of guide walls 118 in combination with the bottom surface 116 may organize the plurality of eggs 102 into single rows, one row per channel 113. The eggs may move through each channel 113 of the feeder 110 toward the conveyor 130 by any desired means, such as by gravity; by vibration; by a conveyor belt; by the force of other eggs 102 entering the feeder 110; by application of fluid, such as through a nozzle (not shown); or by a combination of these or other motive forces. For example, the plurality of eggs 102 may move along the bottom surface 116 of the feeder 110 due to gravity and the urging of the plurality of eggs 102 being loaded onto the feeder proximal end 112 behind the plurality of eggs 102 already moving in the channels 113 between the plurality of guide walls 118. The plurality of eggs 102 may move along the bottom surface 116 of the feeder 110 from the feeder proximal end 112 to the feeder distal end 114.

The plurality of eggs 102 may move from the feeder distal end 114 onto a conveyor 130. The conveyor 130 may comprise a conveyor proximal end 132 and a plurality of egg-receiving positions 134. In an embodiment, each channel 113 aligns with a row of egg-receiving positions 134 on conveyor 130. In an embodiment, he moving conveyor 130 continuously presents egg-receiving positions 134 at the conveyor proximal end 132, wherein the egg-receiving positions 134 are aligned with each channel 113 of the feeder 110.

The conveyor proximal end 132 is thus where the plurality of eggs 102 are transferred from each channel 113 between the plurality of guide walls 118 onto the conveyor 130 and into the plurality of egg-receiving positions 134. The plurality of egg-receiving positions 134 may be equally spaced along the conveyor 130 so that each egg-receiving position 134 optimally receives an egg 102 as the conveyor 130 moves away from the feeder distal end 114.

The fluid nozzle 150 may be operative to emit a stream of fluid 152 between each pair of the plurality of guide walls 118 and aligned with the direction that the eggs 102 are moving down each channel 113. The fluid 152 may comprise any gas or liquid, such as air or water, to name just two non-limiting examples. If more than one fluid nozzle 150 is provided, all of the fluid nozzles 150 may be supplied with fluid 152 by means of a manifold 156 supplying each of the plurality of fluid nozzles 150. The function of the stream of fluid 152 is to urge the plurality of eggs 102 in each channel 113 toward the feeder distal end 114 to position each egg 102 for moving into an egg-receiving position 134 on the conveyor 130.

The system 100 may operate so that when the plurality of eggs 102 are loaded on the feeder proximal end 112, the plurality of eggs 102 moves along the feeder 110 toward the feeder distal end 114. The feeder distal end 114 and the conveyor proximal end 132 may be positioned so that each of the plurality of egg-receiving positions 134 are aligned to accept a respective egg 102 from the feeder distal end 114. Each respective egg 102 may move from the feeder distal end 114 into a respective egg-receiving position 134 on the conveyor proximal end 132 as the conveyor 130 moves away from the feeder distal end 114 toward, e.g., a washer or other process (not shown).

For optimum efficiency of the system 100, it is desired that each egg-receiving position on the conveyor 130 is filled with an egg 102. This will result in the conveyor 130 moving the maximum number of eggs 102 during any given period. In order to ensure that each egg-receiving position 134 is filled with an egg 102, an egg 102 must be positioned at the distal end 114 of the feeder 110 every time the conveyor 130 presents an egg-receiving position 134 at the distal end of the feeder 110. However, the eggs 102 tend to move from the proximal end 112 of the feeder 110 to the distal end 114 of the feeder 110 in a somewhat random fashion, resulting in there sometimes not being an egg 102 present at the distal end 114 of the feeder 110 when the conveyor 130 presents an egg-receiving position 134. As a result, the egg-receiving position 134 remains unfilled and the efficiency of the conveyor 130 is decreased.

To remedy this situation, the fluid nozzles 150 may be positioned proximal to the feeder distal end 114 such that the fluid stream 152 from each fluid nozzle 150 urges each egg 102 within each channel 113 toward the feeder distal end 114 to remove any gaps between adjacent eggs 102 within a channel 113, so that each egg 102 is positioned to move into each respective egg-receiving position 134 at the conveyor proximal end 132 as the conveyor 130 moves past the feeder distal end 114. The fluid stream 152 from the fluid nozzle 150 may be used to reduce a plurality of empty egg-receiving positions 134 on the conveyor 130 by ensuring that the eggs 102 are continuously urged toward the feeder distal end 114 and ready to transfer to the next available egg-receiving position 134, thus operating the system 100 more efficiently.

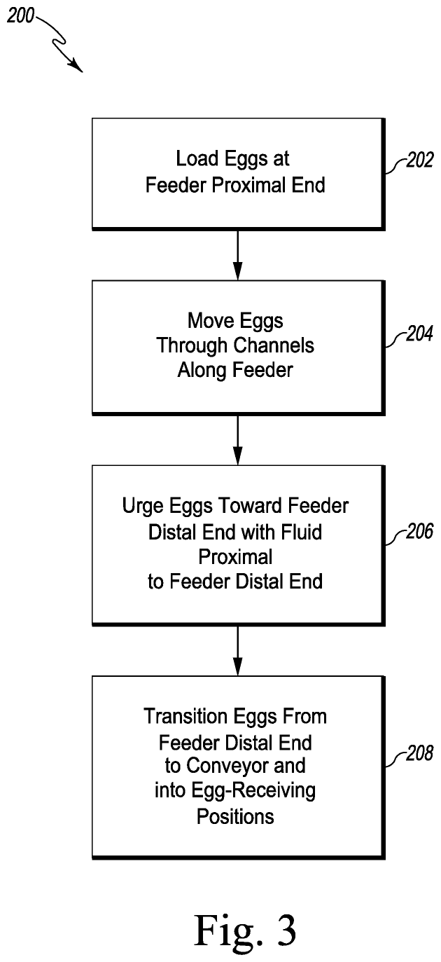

Referring now to FIG. 3, an illustrative method 200 is provided for handling a plurality of eggs using the system 100 described hereinabove. The method 200 begins in block 202, in which the plurality of eggs 102 is loaded on the feeder proximal end 112 of the feeder 110. The method 200 proceeds to block 204, wherein the eggs 102 move through the feeder 110 toward the feeder distal end 114.

In block 204, the plurality of eggs 102 are moved from the feeder proximal end 112 toward a feeder distal end 114. The plurality of eggs 102 move along the channels 113 between the plurality of guide walls 118. The method 200 proceeds to block 206, wherein the plurality of eggs is urged toward the feeder distal end.

In block 206, as the plurality of eggs 102 moves along the feeder 110 through the channels 113, at least one nozzle 150 emits a stream of fluid 152 into each of the plurality of channels 113 proximal to the feeder distal end 114 and directed toward the feeder distal end 114. Each of the nozzles 150 is positioned proximal to the feeder distal end 114 such that the stream of fluid 152 from each nozzle 150 urges the plurality of eggs 102 in the respective channel 113 toward the feeder distal end 114 to minimize or eliminate gaps between adjacent eggs 102 in each channel 113. The method 200 proceeds to block 208, wherein the plurality of eggs 102 moves from the feeder 110 to a conveyor 130.

In block 208, the plurality of eggs 102 transitions from the feeder distal end 114 to the plurality of egg-receiving positions 134 of the conveyor 130. The egg-receiving positions 134 are spaced along the conveyor 130 for receiving the plurality of eggs 102, and the action of the fluid 152 urging the eggs 102 toward the feeder distal end 114 minimizes gaps between the plurality of eggs 102 and maximizes the chance that there will be an egg 102 at the feeder distal end 114 to transfer into each egg-receiving position 134 as it is presented by the conveyor 130.

While the present disclosure has been illustrated and described in detail in the drawings and foregoing description, the same is to be considered as illustrative and not restrictive in character, it being understood that only certain embodiments have been shown and described, and that all changes and modifications that come within the spirit of the present disclosure are desired to be protected.

1. A system for handling a plurality of eggs, the system comprising:
a feeder comprising a feeder proximal end for receiving the plurality of eggs, a feeder distal end opposite the feeder proximal end, a bottom surface, and a plurality of guide walls extending from the bottom surface between the feeder proximal end and the feeder distal end forming a plurality of channels between the plurality of guide walls;
a conveyor comprising a conveyor proximal end and a plurality of egg-receiving positions spaced along the conveyor for receiving the plurality of eggs;
at least one nozzle operative to emit a stream of fluid between pairs of the plurality of guide walls;
wherein the plurality of eggs moves from the feeder proximal end along the bottom surface through the plurality of channels until each of the plurality of eggs reaches the feeder distal end;
wherein the feeder distal end and the conveyor proximal end are positioned so that each of the plurality of egg-receiving positions is aligned to accept a respective one of the plurality of eggs from the feeder distal end;
wherein the nozzle is positioned proximal to the feeder distal end such that the stream of fluid urges the plurality of eggs to the feeder distal end so that the plurality of eggs is positioned to move into the plurality of egg-receiving positions as the conveyor proximal end moves past the feeder distal end.

2. The system of claim 1, wherein the system separates the plurality of eggs into the channels prior to loading the plurality of eggs onto the conveyor.

3. The system of claim 1, wherein the conveyor carries the plurality of eggs through a washing process.

4. The system of claim 1, wherein the plurality of channels organizes the plurality of eggs into a plurality of rows.

5. The system of claim 1, wherein the plurality of eggs moves along the bottom surface of the feeder at least by one of: a gravitational pull; a vibrational energy; a conveyor belt; a force generated by the plurality of eggs entering the feeder; by application of fluid, such as through the nozzle; or by a combination thereof

6. The system of claim 1, wherein the plurality of eggs at the feeder distal end move onto the conveyor proximal end immediately upon exiting the plurality of channels.

7. The system of claim 1, wherein the plurality of egg-receiving positions is equally spaced along the conveyor so that each egg-receiving position may receive an egg as the conveyor moves away from the feeder distal end.

8. The system of claim 1, wherein the nozzle emits the stream of fluid between pairs of the plurality of guide walls proximal to the feeder distal end, the stream of fluid selected from the group consisting of: air, water, and a combination of air and water.

9. A method of handling a plurality of eggs, the method comprising:
loading the plurality of eggs onto a feeder proximal end;
moving the plurality of eggs from the feeder proximal end to a feeder distal end opposite the feeder proximal end along a bottom surface and between a plurality of guide walls extending from the bottom surface between the feeder proximal end and the feeder distal end, the plurality of guide walls forming a plurality of channels;
transitioning the plurality of eggs from the feeder distal end to a conveyor comprising a conveyor proximal end and a plurality of egg-receiving positions spaced along the conveyor for receiving the plurality of eggs;
urging the plurality of eggs moving along the feeder through the plurality of channels with at least one nozzle operative to emit a stream of fluid into the plurality of channels proximal to the feeder distal end;
wherein the plurality of eggs moving from the feeder proximal end travel through the channels until each of the plurality of eggs reaches the feeder distal end;
wherein the feeder distal end and the conveyor proximal end are positioned so that each of the plurality of egg-receiving positions is aligned to accept a respective one of the plurality of eggs from the feeder distal end; and
wherein the nozzle is positioned proximal to the feeder distal end such that the stream of fluid urges the plurality of eggs into position to move into the plurality of egg-receiving positions as the conveyor proximal end moves past the feeder distal end.

10. The method of claim 9, wherein the conveyor carries the plurality of eggs through a washing process.

11. The method of claim 9, wherein the plurality of eggs moves along the bottom surface of the feeder at least by one of: a gravitational pull; a vibrational energy; a conveyor belt; a force generated by the plurality of eggs entering the feeder; by application of fluid, such as through the nozzle; or by a combination thereof

12. The method of claim 9, wherein the plurality of eggs moves from between the plurality of guide walls onto the conveyor proximal end immediately upon exiting the feeder distal end.

13. The method of claim 9, wherein the plurality of egg-receiving positions is equally spaced along the conveyor so that each egg-receiving position may receive an egg as the conveyor moves away from the feeder distal end.

14. The method of claim 9, wherein the nozzle emits the stream of fluid between pairs of the plurality of guide walls proximal to the feeder distal end, the stream of fluid selected from the group consisting of: air, water, and a combination of air and water.

15. The method of claim 9, wherein the stream of fluid urges the plurality of eggs from between the plurality of guide walls to the feeder distal end to position the plurality of eggs to move into the plurality of egg-receiving positions immediately upon exiting the plurality of channels.
